(19) United States
(12) Patent Application Publication
(10) Pub. No.: US 2017/0254302 A1
(43) Pub. Date: Sep. 7, 2017

(54) FUEL SUPPLY DEVICE

(71) Applicants: DENSO CORPORATION, Kariya-city, Aichi-pref. (JP); KYOSAN DENKI CO., LTD., Koga-city, Ibaraki-pref. (JP)

(72) Inventors: Hideto TAKAHASHI, Kariya-city (JP); Masaharu OOHASHI, Kariya-city (JP); Tetsuro OKAZONO, Kariya-city (JP); Hironobu OKI, Koga-city (JP)

(21) Appl. No.: 15/506,030

(22) PCT Filed: Aug. 26, 2015
(86) PCT No.: PCT/JP2015/004279

§ 371 Date: Feb. 23, 2017

(30) Foreign Application Priority Data
Aug. 29, 2014 (JP) 2014-175194

(51) Int. Cl. F02M 37/18; F02M 37/00; F02M 37/10; F02M 37/22

(52) U.S. Cl. CPC F02M 37/18; F02M 37/22; F02M 37/0011; F02M 37/10

(57) ABSTRACT

A communication port opens at a shifted position of a fuel passage that is positionally shifted from an inside residual pressure holding valve toward an outside residual pressure holding valve. The fuel passage includes an outside passage part through which the fuel to be discharged into an internal-combustion engine flows from the communication port toward the outside residual pressure holding valve, and an inside passage part that throttles a flow of fuel flowing from the communication port toward the inside residual pressure holding valve more than the outside passage part. When a passage cross-sectional area of the inside passage part is converted into a passage cross-sectional area of a circular pipe, D which is a passage diameter of the circular pipe, and L which is a length of the inside passage part satisfy a relational expression of L/D≧3.

### CROSS REFERENCE TO RELATED APPLICATION

This application is based on Japanese Patent Application No. 2014-175194 filed on Aug. 29, 2014, the disclosure of which is incorporated herein by reference.

### TECHNICAL FIELD

The present disclosure relates to a fuel supply device that supplies fuel in a fuel tank to an internal combustion engine.

### BACKGROUND ART

A fuel supply device that filters fuel, which is pressure-sent from an interior of a fuel tank by a fuel pump, by a fuel filter received in a receiving chamber of a filter case to thereby supply the fuel to an internal combustion engine side has been mounted in a vehicle, thereby having been widely used.

In a device which is a kind of such a fuel supply device and which is disclosed in a Patent Document 1, from an inflow port communicating with a receiving chamber on a downstream side of a fuel filter of a fuel passage provided in a filter case, fuel discharged to an internal combustion engine side is circulated in the fuel passage. In this device disclosed in the Patent Document 1, when a fuel pump is stopped, a pressure of the fuel supplied to the internal combustion engine side is held by an outside residual pressure holding valve provided in the filter case, whereby when the fuel is again supplied, a response delay caused by a decrease in the pressure of the fuel supplied to the internal combustion engine side can be avoided. In addition, in the device disclosed in the Patent Document 1, when the fuel pump is stopped, the pressure of the fuel in the receiving chamber is held by an inside residual pressure holding valve provided in the filter case to thereby inhibit the fuel from being vaporized, whereby when the fuel is again supplied, a response delay caused by the fuel being vaporized can be avoided.

### PRIOR ART DOCUMENT

### Patent Document

Patent Document 1: JP 2007-239682A

Incidentally, in the device disclosed in the Patent Document 1, each of the outside residual pressure holding valve and the inside residual pressure holding valve is a valve of a spring-biased type and opens a valve element against a spring reaction force when the fuel pump is actuated. In each of the outside residual pressure holding valve of this spring-biased type and the inside residual pressure holding valve of this spring-biased type, according to a pressure pulsation caused by the fuel being pressure-sent from the fuel pump, the valve element is vibrated to thereby amplify the pressure pulsation, which hence easily causes noise in a path from the fuel passage to the internal combustion engine. Here, the present inventors earnestly conducted research and found the following fact: an inflow port of each of the outside residual pressure holding valve and the inside residual pressure holding valve functions as a part for throttling a fuel flow, but the inflow port is constructed in such a way that a length is shorter than a diameter, so that the inflow port is insufficient to attenuate the pressure pulsation and to reduce the noise.

### SUMMARY OF INVENTION

The present disclosure addresses the above issues. Thus, it is an objective of the present disclosure to provide a fuel supply device that can reduce noise.

To achieve the objective of the present disclosure, a fuel supply device in a first aspect of the present disclosure includes a fuel pump, a filter case, a fuel passage, a spring-less type outside residual pressure holding valve, and a spring-urged type inside residual pressure holding valve. The filter case receives a fuel filter in its receiving chamber. The fuel supply device filters fuel, which is pressure-sent from an interior of a fuel tank by the fuel pump, through the fuel filter and supplies fuel to an internal-combustion engine. The fuel passage is provided in the filter case and includes a communication port, which communicates with the receiving chamber on a downstream side of the fuel filter. Fuel to be discharged through the communication port into the internal-combustion engine flows through the fuel passage. The outside residual pressure holding valve is provided at the filter case and holds a pressure of the fuel supplied to the internal-combustion engine when the fuel pump is stopped. The outside residual pressure holding valve includes a valve stopper and a valve element, which opens the outside residual pressure holding valve when the fuel pump is actuated to be engaged with the valve stopper. The inside residual pressure holding valve is provided at the filter case and holds a pressure of fuel in the receiving chamber when the fuel pump is stopped. The inside residual pressure holding valve includes a valve element, which opens the inside residual pressure holding valve against spring reaction force when the fuel pump is actuated. The communication port opens at a shifted position of the fuel passage that is positionally shifted from the inside residual pressure holding valve toward the outside residual pressure holding valve. The fuel passage includes an outside passage part and an inside passage part. The fuel to be discharged into the internal-combustion engine flows from the communication port toward the outside residual pressure holding valve through the outside passage part. The inside passage part throttles a flow of fuel flowing from the communication port toward the inside residual pressure holding valve more than the outside passage part. When a passage cross-sectional area of the inside passage part is converted into a passage cross-sectional area of a circular pipe, D which is a passage diameter of the circular pipe, and L which is a length of the inside passage part satisfy a relational expression of L/D≧3.

According to this aspect, the outside residual pressure holding valve that holds the pressure of the fuel supplied to the internal combustion engine side when the fuel pump is stopped is a valve of a spring-less type having the valve element which is opened and retained by the valve stopper when the fuel pump is actuated. For this reason, even when a pressure pulsation is caused by the fuel being pressure-sent from the fuel pump, the valve element retained by the valve stopper is hard to be vibrated.

On the other hand, the inside residual pressure holding valve that holds the pressure of the fuel in the receiving chamber when the fuel pump is stopped is a valve of a spring-biased type having the valve element which is opened against the spring reaction force when the fuel pump is actuated. Here, of the fuel passage for circulating the fuel discharged to the internal combustion engine side, the communication port, which communicates with the receiving chamber on the downstream side of the fuel filter, opens at a shifted position which is shifted in position from the inside residual pressure holding valve to the outside residual pressure holding valve. In this way, in the fuel passage, the length L of the inside passage part, which throttles the fuel flow from the communication port to the inside residual pressure holding valve side, can be enlarged in such a way as to satisfy the relational expression of L/D≧3 as compared with the outside passage part in which the fuel is directed from the communication port to the outside residual pressure holding valve. As a result, the pressure pulsation caused by the fuel being pressure-sent from the fuel pump can be attenuated by the inside passage part which is long extended to the inside residual pressure holding valve of a spring biased type to thereby throttle the fuel flow, so that also the vibration of the valve element in the inside residual pressure holding valve can be attenuated.

From the above description, in either of the outside residual pressure holding valve and the inside residual pressure holding valve, the pressure pulsation can be inhibited from being amplified by the vibration of the valve element, which hence can reduce noise caused in the path from the fuel passage to the internal combustion engine.

The fuel supply device in a second aspect of the present disclosure further includes a relay passage that is provided in the filter case to communicate between the receiving chamber and the communication port.

According to this aspect, the communication port, which communicates with the receiving chamber via the relay passage, opens at the shifted position which is shifted in position from the inside residual pressure holding valve to the outside residual pressure holding valve. According to this construction, not only the length L of the inside passage part, which throttles the fuel flow from the communication port to the inside residual pressure holding valve side, can be enlarged in such a way as to satisfy the relational expression of L/D≧3, but also the length of the relay passage from the receiving chamber to the communication port can be enlarged. As a result, before the pressure pulsation which is caused by the fuel being pressure-sent from the fuel pump reaches the inside residual pressure holding valve, the pressure pulsation can be attenuated by the long relay passage and the inside passage part which is long extended to thereby throttle the fuel flow. Hence, it is possible to improve an effect of reducing noise.

In a third aspect of the present disclosure, the communication port opens into the outside passage part at the shifted position. The inside passage part opens at a separated position of the outside passage part that is separated from the relay passage with the inside residual pressure holding valve between the separated position and the relay passage to communicate with the communication port via the outside passage part.

According to this aspect, the communication port, which opens in the outside passage part at the shifted position which is shifted in position from the inside residual pressure holding valve to the outside residual pressure holding valve, communicates with the inside passage part via the outside passage part. Here, the fuel flow is more throttled in the inside passage part than in the outside passage part, so that a flow rate of the fuel circulated in the outside passage part so as to be discharged to the internal combustion engine side can be secured and at the same time the pressure pulsation can be attenuated in the inside passage part to thereby reduce noise. Further, the inside passage part opens at the separated position which is separated from the relay passage across the inside residual pressure holding valve of the outside passage part, so that a distance from the communication port to the separated position of the outside passage part can be increased together with the length of the relay passage. As a result, before the pressure pulsation which is caused by the fuel being pressure-sent from the fuel pump reaches the inside residual pressure holding valve of a spring-biased type, the pressure pulsation can be attenuated by the long relay passage, the distance secured between the shifted position and the separated position, and the inside passage part which is long extended to thereby throttle the fuel flow. Hence, it is possible to improve the effect of reducing noise.

### BRIEF DESCRIPTION OF DRAWINGS

The above and other objects, features, and advantages of the present disclosure will become more apparent from the following detailed description made with reference to the accompanying drawings. In the drawings:

FIG. 1 is a figure to show a fuel supply device according to one embodiment and is a section view taken along a line I-I in FIG. 3;

FIG. 2 is a figure to show a pomp unit in FIG. 1 and is a section view taken along a line II-II in FIG. 3;

FIG. 3 is a section view taken along a line III-III in FIG. 1;

FIG. 4A is a schematic figure to illustrate a feature of the fuel supply device according to one embodiment, showing a minimum passage cross-sectional area of an inside passage part;

FIG. 4B is a schematic figure to illustrate a feature of the fuel supply device according to one embodiment, showing a passage cross-sectional area of a circular pipe;

FIG. 5 is a partial section view to show the fuel supply device in FIG. 1;

FIG. 6 is a characteristic diagram to show an operation and effect of the fuel supply device according to one embodiment; and

FIG. 7 is a characteristic diagram to show an operation and effect of the fuel supply device according to one embodiment.

### EMBODIMENT FOR CARRYING OUT INVENTION

Hereinafter, one embodiment will be described with reference to the drawings.

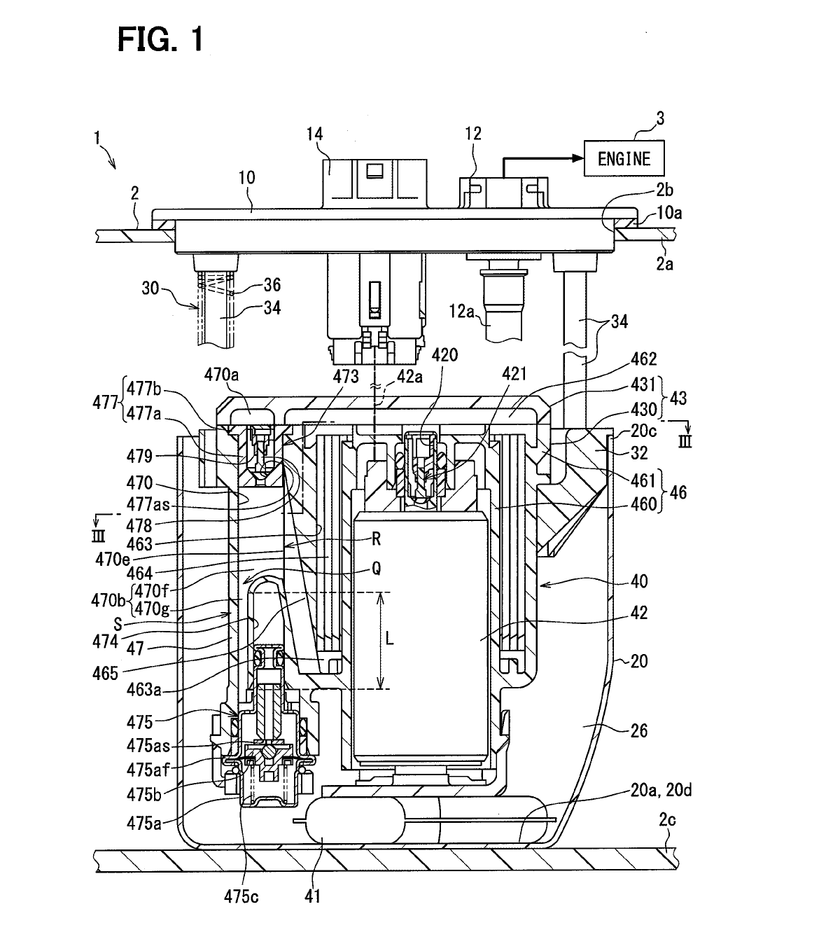

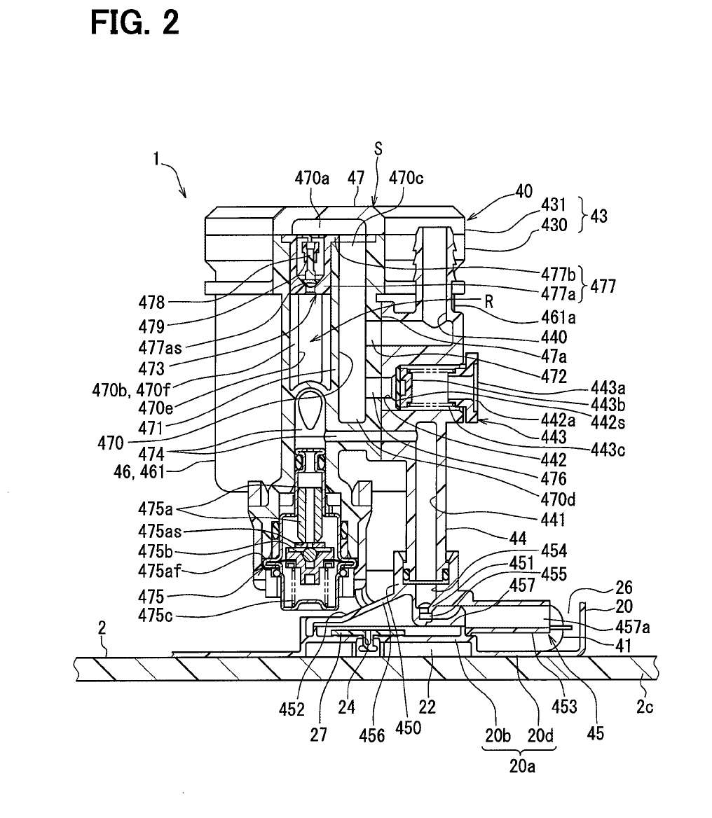

As shown in FIG. 1 and FIG. 2, a fuel supply device 1 according to one embodiment is mounted in a fuel tank 2 of a vehicle. The fuel supply device 1 supplies fuel in the fuel tank 2 to a fuel injection valve of an internal combustion engine 3 directly or indirectly via a high pressure pump or the like. Here, the fuel tank 2 mounted in the fuel supply device 1 is formed of resin or metal in a hollow shape, thereby storing the fuel to be supplied to the internal combustion engine 3 side. Further, the internal combustion engine 3 to which the fuel is supplied from the fuel supply device 1 may be a gasoline engine or a diesel engine. In this regard, a vertical direction of the fuel supply device 1 shown in FIG. 1 and FIG. 2 substantially matches a vertical direction of the vehicle on a horizontal plane.

Hereinafter, a construction and an action of the fuel supply device 1 will be described.

As shown in FIG. 1 to FIG. 3, the fuel supply device 1 includes a flange 10, a sub-tank 20, a regulation mechanism 30, and a pump unit 40.

As shown in FIG. 1, the flange 10 is made of resin in a shape of a circular disc and is attached to a top plate part 2a of the fuel tank 2. The flange 10 closes a through hole 2b formed in the top plate part 2a by a packing 10a sandwiched between the flange 10 and the top plate part 2a. The flange 10 is integrally provided with a fuel supply pipe 12 and an electric connector 14.

The fuel supply pipe 12 is protruded to both upper and lower sides from the flange 10. The fuel supply pipe 12 communicates with the pump unit 40 via a flexible tube 12a that is freely curved. Since the fuel supply pipe 12 communicates with the pomp unit 40 in this way, the fuel supply pipe 12 supplies the fuel, which is pressure-sent from an interior of the fuel tank 2 by a fuel pump 42 of the pump unit 40, to the internal combustion engine 3 side outside the fuel tank 2. The electric connector 14 is also protruded to both upper and lower sides from the flange 10. The electric connector 14 electrically connects the fuel pump 42 to an external circuit which is not shown in the drawing. By this electric connection, the fuel pump 42 is controlled by the external circuit.

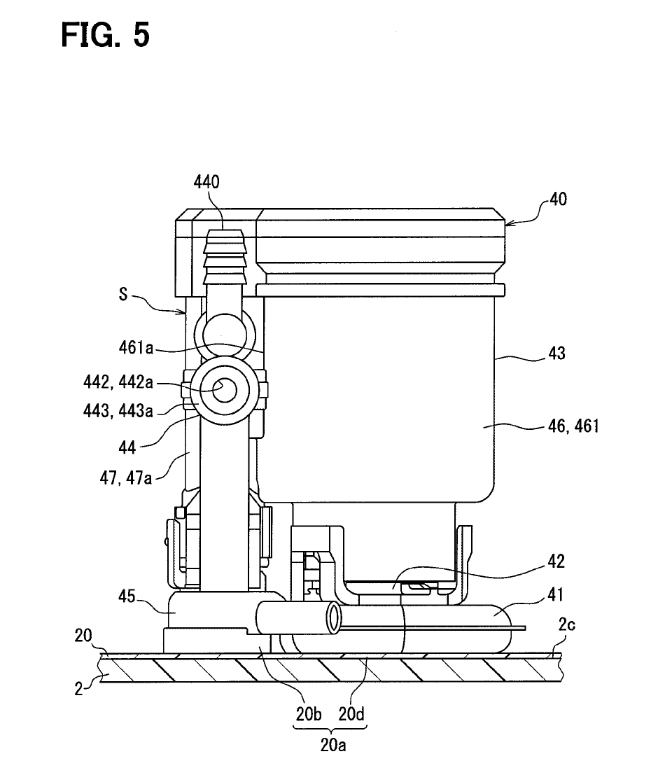

As shown in FIG. 1, FIG. 2, and FIG. 5, the sub-tank 20 is formed of resin in a shape of a circular cylinder having a bottom and is received in the fuel tank 2. A bottom part 20a of the sub-tank 20 is placed on a bottom part 2c of the fuel tank 2. Here, as shown in FIG. 2, a depressed bottom part 20b depressed upward of the bottom part 20a has an inflow space 22 formed between the bottom part 2c and the depressed bottom part 2b itself. Further, the depressed bottom part 20b has an inflow port 24 formed therein. The inflow port 24 communicates with an interior of the fuel tank 2 via the inflow space 22. Since the inflow port 24 communicates with the fuel tank 2 in this way, the inflow port 24 makes the fuel flow into the sub-tank 20, the fuel being transported from the interior of the fuel tank 2 by a jet pump 45 of the pump unit 40. The fuel flowing into the sub-tank 20 through the inflow port 24 is stored in an internal space 26 (see also FIG. 1) of the sub-tank 20 including the surroundings of the fuel pump 42. In this regard, the depressed bottom part 20b of the present embodiment has an umbrella valve 27 provided thereon in such a way that the umbrella valve 27 opens the inflow port 24 when a negative pressure is applied from the jet pump 45 which will be described later in detail.

As shown in FIG. 1, the regulation mechanism 30 is constructed of a holding member 32, a pair of support columns 34, a resilient member 36, and the like.

The holding member 32 is formed of resin in a shape of a circular ring and is attached to an upper part 20c of the sub-tank 20 in the fuel tank 2. Each of the support columns 34 is formed of metal in a shape of a circular cylinder and is received in the fuel tank 2 and is extended in the vertical direction. An upper end portion of each support column 34 is fixed to the flange 10. Each support column 34 is slidably guided in the vertical direction by the holding member 32 below the upper end portion thereof in a state where each support column 34 is inserted into the sub-tank 20.

The resilient member 36 is formed of metal in a shape of a coil spring and is received in the fuel tank 2. The resilient member 36 is arranged coaxially around one corresponding support column 34. The resilient member 36 is interposed between the corresponding support column 34 and the holding member 32 in the vertical direction. Since the resilient member 36 is interposed in this way, the resilient member 36 presses the bottom part 20a of the sub-tank 20 to the bottom part 2c of the fuel tank 2 via the holding member 32.

As shown in FIG. 1, FIG. 2, and FIG. 5, the pump unit 40 is received in the fuel tank 2. The pump unit 40 is constructed of a suction filter 41, a fuel pump 42, a filter case 43, a port member 44, the jet pump 45, and the like.

The suction filter 41 is, for example, a non-woven fabric filter or the like and is placed on a deepest bottom part 20d surrounding a periphery of the depressed bottom part 20b of the bottom part 20a in the sub-tank 20. The suction filter 41 filters the fuel to be sucked by the fuel pump 42 from the internal space 26 of the sub-tank 20, thereby removing large foreign matters in the fuel to be sucked.

The fuel pump 42 is arranged above the suction filter 41 in the sub-tank 20. The fuel pump 42 formed, as a whole, in a shape of a circular cylinder has its axial direction substantially matched with the vertical direction. The fuel pump 42 is an electric pump in the present embodiment. The fuel pump 42, as shown in FIG. 1, is electrically connected to the electric connector 14 via a flexible wiring 42a which is freely curved. The fuel pump 42 is subjected to a drive control from the external circuit through the electric connector 14, thereby being actuated. Here, while the fuel pump 42 is actuated, the fuel pump 42 sucks the fuel stored around itself through the suction filter 41 and pressurizes the sucked fuel in itself to thereby regulate the pressure of the fuel.

The fuel pump 42 is integrally provided with a delivery valve 421 at a delivery port 420 from which the fuel is delivered. The delivery valve 421 is a check valve of a spring-less type in the present embodiment. While the fuel pump 42 is actuated to pressurize the fuel, the delivery valve 421 is opened. When the delivery valve 421 is opened, the fuel is pressure-sent from the delivery port 420 to an interior of the filter case 43. On the other hand, when the fuel pump 42 is stopped to stop pressurizing the fuel, the delivery valve 421 is closed. When the delivery valve 421 is closed, the fuel is stopped from being pressure-sent to the interior of the filer case 43. In the present embodiment, a pressure of the pressurized fuel discharged from the fuel pump 42 is variably regulated, for example, within a range from 300 kPa to 600 kPa.

As shown in FIG.1 and FIG. 2, the filter case 43 is formed of resin in a hollow shape and is arranged inside and outside the sub-tank 20 in the vertical direction. The filter case 43 is held by the holding member 32, thereby being positioned with respect to the sub-tank 20.

A receiving part 46 of the filter case 43 is formed of an inner cylinder part 460 and an outer cylinder part 461 in a shape of double circular cylinders and is coaxially arranged around the fuel pump 42. Since the receiving part 46 is arranged in this way, an axial direction of the filter case 43 is along the vertical direction. As shown in FIG. 1, the receiving part 46 has a communication chamber 462 formed in a shape of a flat space, the communication chamber 462 communicating with the delivery port 420 above the inner cylinder part 460 and the outer cylinder part 461.

Further, the receiving part 46 has a receiving chamber 463 formed in a shape of a circular cylindrical hole, the receiving chamber 463 communicating with the communication chamber 462 between the inner cylinder part 460 and the outer cylinder part 461. In the receiving chamber 463 is received a fuel filter 464 formed in a shape of a circular cylinder. The fuel filter 464 is made of, for example, a honeycomb filter and filters the pressurized fuel delivered from the delivery port 420 to the receiving chamber 463 via the communication chamber 462, thereby removing minute foreign matters in the pressurized fuel.

Still further, the receiving part 46 has a relay passage 465 formed nearly in a shape of a nearly rectangular hole inclined with respect to an axial direction of the filter case 43 arranged along the vertical direction, the relay passage 465 communicating with the receiving chamber 463. The relay passage 465 communicates with a fuel outlet 463a, which opens below the fuel filter 464, of the receiving chamber 463. As the relay passage 465 is further separated from the fuel outlet 463a in a radial outward direction, the relay passage 465 is straightly inclined diagonally upward. The relay passage 465 inclined in this way guides the fuel, which is filtered by the fuel filter 464 and sent out from the fuel outlet 463a, in a diagonally upward direction.

In this regard, the filter case 43 of the present embodiment is made by bonding a case cap 431 to a case main body 430 by welding. The case main body 430 is a part which forms the receiving chamber 463 and the relay passage 465 of the receiving part 46 and which has a bottom. The case chap 431 is a depressed part which forms the communication chamber 462 of the receiving part 46.

As shown in FIG. 1 to FIG. 3, a protruding part 47 of the filter case 43 protrudes in the radial outward direction directed to a specified position S in a peripheral direction of the filter case 43 from the outer cylinder part 461 (see also FIG. 5). In the protruding part 47 are received a fuel passage 470, a partition wall 471, a discharge passage 472, an outside residual pressure holding valve 473, a branch passage 474, an inside residual pressure holding valve 475, and a relief passage 476. In other words, the protruding part 47 is integrally provided with these elements 470, 471, 472. 473, 474, 475, and 476 in a manner concentrated at the specified position S in a peripheral direction of the filter case 43.

The fuel passage 470 is formed in the protruding part 47 in a shape of space expanding in a shape of an inverse letter U. The fuel passage 470 is partitioned by the partition wall 471, thereby being folded back in the axial direction of the filter case 43 along the vertical direction. Here, the fuel passage 470 is partitioned straightly by the partition wall 471 shaped like a flat belt. Since the fuel passage 470 is partitioned in this way, in the fuel passage 470, an upstream straight part 470b and a downstream straight part 470c are extended downward in a shape of a nearly straight rectangular cylindrical hole from both ends of a folding-back part 470a positioned uppermost. In other words, the fuel passage 470 is constructed of the folding-back part 470a, the upstream straight part 470b arranged on an upstream side of the folding-back part 470a, and the downstream straight part 470c arranged on a downstream side of the folding-back part 470a. In this regard, in the present embodiment, both of the upstream straight part 470b and the downstream straight part 470c are formed in the case main body 430, whereas the folding-back part 470a is formed in the case cap 431.

The fuel passage 470 has a communication port 470e formed therein in such a way that the communication port 470e opens in a middle portion in the vertical direction of the upstream straight part 470b. The upstream straight part 470b makes the communication port 470e communicate with the receiving chamber 463 via the relay passage 465, thereby being arranged on the downstream side of the fuel filter 464. According to this arrangement, the pressurized fuel guided through the relay passage 465 is sent out from the communication port 470e to the upstream straight part 470b. The upstream straight part 470b forms: an outside passage part 470f in which the communication port 470e is opened; and an inside passage part 470g which communicates with communication port 470e via the outside passage part 470f. The outside passage part 470f and the inside passage part 470g are received in the protruding part 47 together with the elements 471, 472, 473, 474, 475, and 476 arranged at the specified position S.

The outside passage part 470f circulates the fuel sent out of the communication part 470e to the outside residual pressure holding valve 473 side above the communication port 470e. According to this circulation mode, a direction in which the fuel is circulated in the relay passage 465, as shown in FIG. 1, is inclined with respect to a direction in which the fuel is circulated in the outside passage part 470f. A passage cross-sectional area of the outside passage part 470f is made larger than a passage cross-sectional area of the relay passage 465 to relay the communication port 470e to the receiving chamber 463. The outside passage part 470f having the passage cross-sectional area made larger than the relay passage 465 guides the pressurized fuel from the communication part 470e toward the downstream straight part 470c so as to discharge the pressurized fuel from the discharge passage 472.

The fuel, which is guided by the relay passage 465 and sent out of the communication port 470e, is folded back to the inside residual pressure holding valve 475 arranged below through the outside passage part 470f, thereby being circulated toward the inside passage part 470g. In order to realize this circulation mode, the direction in which the fuel is circulated in the relay passage 465 is inclined also with respect to the direction in which the fuel is circulated in the inside passage part 470g. A passage cross-sectional area of the inside passage part 470g is made smaller than a passage cross-sectional area of the relay passage 465 and the passage cross-sectional area of the outside passage part 470f. Since the inside passage part 470g has the passage cross-sectional area made smaller in this way, a fuel flow directed to the inside residual pressure holding valve 475 side in the inside passage part 470g is throttled more than a fuel flow in the outside passage part 470f.

Here, a minimum passage cross-sectional area of the inside passage part 470g, which is denoted by hatching in FIG. 4A, is imaginarily transformed as a passage cross-sectional area of a circular pipe P, which is denoted by hatching in FIG. 4B. Then, a passage diameter D of the circular pipe P, which is shown in FIG. 4B and is found from the transformed passage cross-sectional area, and a length L of the inside passage part 470g, which is shown in FIG. 1 and is found as a distance from the outside passage part 470f to the inside residual pressure holding valve 475, are set in such a way as to satisfy a relational expression of L/D≧3. Here, a reason why the passage diameter D and the length L are set in such a way as to satisfy the relational expression of L/D≧3 will be described later in detail.

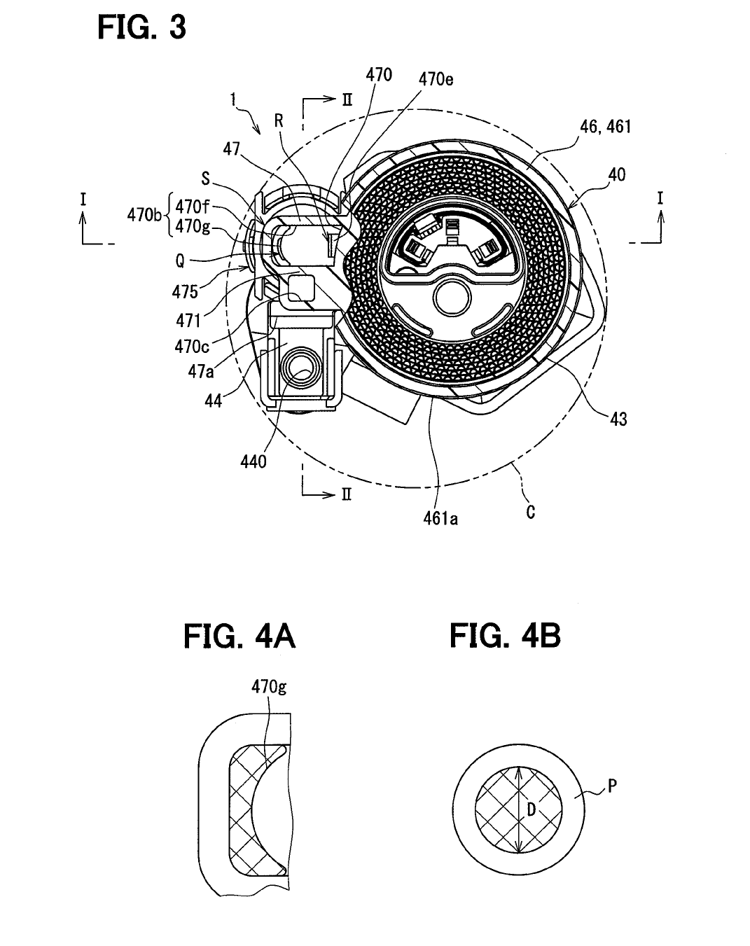

Further, the inside residual pressure holding valve 475 arranged on the downstream side of the inside passage part 470g, as shown in FIG. 1 to FIG. 3, is arranged separately below the outside residual pressure holding valve 473. In this arrangement, in the outside passage part 470f, the communication port 470e opens at a shifted position R, which is shifted in position from the inside residual pressure holding valve 475 to the outside residual pressure holding valve 473, and the inside passage part 470g opens below the shifted position R. Further, as shown in FIG. 1 and FIG. 3, an opening of the inside passage part 470g is formed at a separated position Q which is separated in the radial outward direction across the inside residual pressure holding valve 475 from the relay passage 465 of the outside passage part 470f.

As shown in FIG. 2, the discharge passage 472 is formed in a shape of a circular cylinder in a middle portion in the vertical direction of the protruding part 47. The discharge passage 472 is branched in a direction orthogonal to the axial direction of the filter case 43 from the downstream straight part 470c on the downstream side of the commination port 470e and the outside passage part 470f in the fuel passage 470. The discharge passage 472 communicates with the discharge port 440 of a port member 44, thereby discharging the fuel circulated in the fuel passage 470 to the internal combustion engine 3 side through the flexible tube 12a and the fuel supply pipe 12. At this time, in the fuel passage 470, the fuel branched from a flow directed to the internal combustion engine 3 side from the discharge passage 472 is circulated on the downstream side of the discharge passage 472.

As shown in FIG. 1 and FIG. 2, the outside residual pressure holding valve 473 is a check valve of a spring-less type and is provided in the outside passage part 470f on the downstream side of the communication port 470e and on the upstream side of the discharge passage 472 of the upstream straight part 470b. In other words, the outside residual pressure holding valve 473 is arranged in a middle portion of a path from the communication port 470e to the discharge passage 472 in the fuel passage 470. The outside residual pressure holding valve 473 includes a valve housing 477, a valve element 478, and a valve stopper 479.

In the valve housing 477, a cylindrical housing main body 477a and a plate-shaped bonded plate 477b are integrally molded of resin. The housing main body 477a is fitted in the protruding part 47 of the case main body 430. The outside passage part 470f as a portion of the upstream straight part 470b is passed through the housing main body 477a. The housing main body 477a has a valve seat 477as formed around the outside passage part 470f, the valve seat 477as being formed in a shape of a circular cone whose diameter is reduced to an upstream side of the outside passage part 470f. The bonded plate 477b is sandwiched between the case main body 430 and the case cap 431. The bonded plate 477b is projected from the housing main body 477a toward a direction orthogonal to the axial direction of the filter case 43. The outside passage part 470f and a portion of the downstream straight part 470c are passed through the bonded plate 477b.

The valve element 478 is formed of a composite material of resin and rubber in a shape of a circular cylinder and is received coaxially in the housing main body 477a. Since the valve element 478 is received in this way, when the valve element 478 is moved back and forth, the valve element 478 can be seated on and separated from the valve seat 477as. Hence, when the valve element 478 is separated from the valve seat 477as, the outside residual pressure holding valve 473 is opened. On the other hand, when the valve element 478 is seated on the valve seat 477as, the outside residual pressure holding valve 473 is closed.

The valve stopper 479 is formed of resin in a shape of a circular cylinder and is fixed coaxially in the housing main body 477a. The valve stopper 479 supports the valve element 478 in such a way that the valve element 478 can be moved back and forth in the axial direction. When the valve element 478 is separated from the valve seat 47as and hence the outside residual pressure holding valve 473 is opened, the valve stopper 479 retains the valve element 478.

According to this structure, the outside residual pressure holding valve 473 opens and closes the fuel passage 470. Specifically, while the fuel pump 42 is actuated and hence the pressurized fuel is sent out of the communication port 470e to the outside passage part 470f, the valve element 478 of the outside residual pressure holding valve 473 is opened. When the valve element 478 of the outside residual pressure holding valve 473 is opened, the pressurized fuel sent out of the outside passage part 470f is circulated to the discharge passage 472 and to a most downstream side end 470d side of the downstream straight part 470c in a state where the valve element 478 is retained by the valve stopper 479. On the other hand, when the fuel pump 42 is stopped and hence the pressurized fuel is stopped from being sent out of the communication port 470e, the valve element 478 is closed. When the valve element 478 is closed, a circulation of the fuel to the discharge passage 472 and to the most downstream side end 470d side is also stopped, so that the pressure of the fuel, which is discharged from the discharge passage 472 and is supplied to the internal combustion engine 3 side before the valve element 478 is closed, is held. In other words, a residual pressure holding function is exerted to the fuel, which is supplied to the internal combustion engine 3 side through the fuel passage 470, by the closed outside residual pressure holding valve 473. In this regard, a pressure held by the residual pressure holding function of the outside residual pressure holding valve 473 becomes a pressure regulated when the fuel pump 42 is stopped.

The branch passage 474 is formed in a shape of a space expanding from a position, which is sandwiched between the relay passage 465 and the inside passage part 470g at the separated position Q in the radial outward direction in the protruding part 47, to the port member 44 side. The branch passage 474 is branched in such a way as to fold back upward from a lower end opposite to the outside passage part 470f of the inside passage part 470g. The branch passage 474 branched in this way does not cross the downstream straight part 470c. The branch passage 474 communicates with a jet port 441 of the port member 44, thereby guiding the fuel, which is discharged from the inside passage part 470g through the inside residual pressure holding valve 475, to the jet pump 45.

The inside residual pressure holding valve 475 is a check valve of a spring-biased type and is provided in the branch passage 474. The inside residual pressure holding valve 475 is provided with a valve housing 475a, a valve element 475b, and a valve spring 475c.

The valve housing 475a is formed of a composite material of metal in a shape of a stepped circular cylinder and is fitted in the protruding part 47. A portion of the branch passage 474 is passed through the valve housing 475a. The valve housing 475a has a plate-shaped valve seat 475as formed in the branch passage 474. Further, in the valve housing 475a, a flange part 475af shaped like a circular ring plate is provided below the relay passage 465 and below the inside passage part 470g in such a way as to overlap the relay passage 465 and the inside passage part 470g, whereby the inside residual pressure holding valve 475 is positioned by the protruding part 47 and the fuel supply device 1 is reduced in size.

The valve element 475b is formed of a composite material of metal in a shape of a circular cylinder and is received coaxially in the valve housing 475a. Since the valve element 475b is received in this way, when the valve element 475b is moved back and forth, the valve element 475b can be seated on and separated from the valve seat 475as. Hence, when the valve element 475b is separated from the valve seat 475as, the inside residual pressure holding valve 475 is opened. On the other hand, when the valve element 475b is seated on the valve seat 475as, the inside residual pressure holding valve 475 is closed.

The valve spring 475c is formed of metal in a shape of a coil and is retained coaxially in the valve housing 475a. The valve spring 475c biases the valve element 475b to the valve seat 475as side by a spring reaction force.

According to this structure, the inside residual pressure holding valve 475 opens or closes the fuel passage 470 communicating with the branch passage 474. Specifically, while the fuel pump 42 is actuated to send out the fuel, the pressure of which is higher than a set pressure, from the communication passage 470e to the outside passage part 470f and the inside passage part 470g, the valve element 475b of the inside residual pressure holding valve 475 is opened against the spring reaction force of the valve spring 475c. When the valve element 475b of the inside residual pressure holding valve 475 is opened, in a state where the valve element 475b is resiliently held by the valve spring 475c, the pressurized fuel flowing into the branch passage 474 from the inside passage part 470g is circulated to the jet pump 45 side. On the other hand, even if the fuel pump 42 is actuated, when the pressure of the fuel sent out of the communication port 470e is less than the set pressure, or when the fuel pump 42 is stopped and hence the fuel is stopped from being sent out from the communication port 470e, the valve element 475b is closed by the spring reaction force of the valve spring 475c. When the valve element 475b is closed, the circulation of the fuel to the jet pump 45 side is also stopped, so that especially in a case where the fuel pump 42 is stopped, the delivery valve 421 is also closed and hence the pressure of the fuel in the receiving chamber 463 is held at the set pressure of the inside residual pressure holding valve 475. In other words, the residual pressure holding function is exerted to the fuel stored in the receiving chamber 463 by the closed inside residual pressure holding valve 475. In this regard, a pressure held by the residual pressure holding function of the inside residual pressure holding valve 475 is set to, for example, 250 kPa.

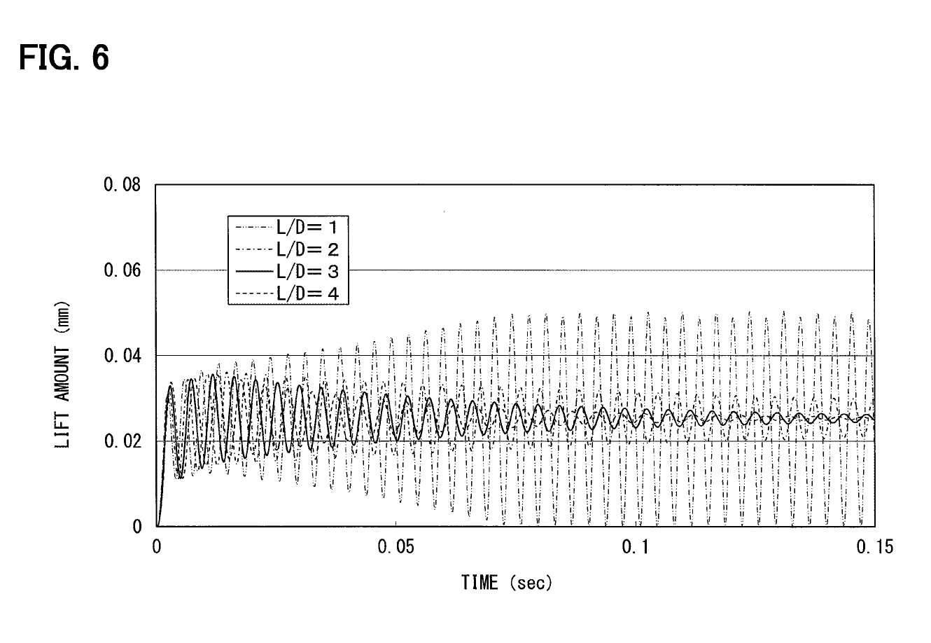

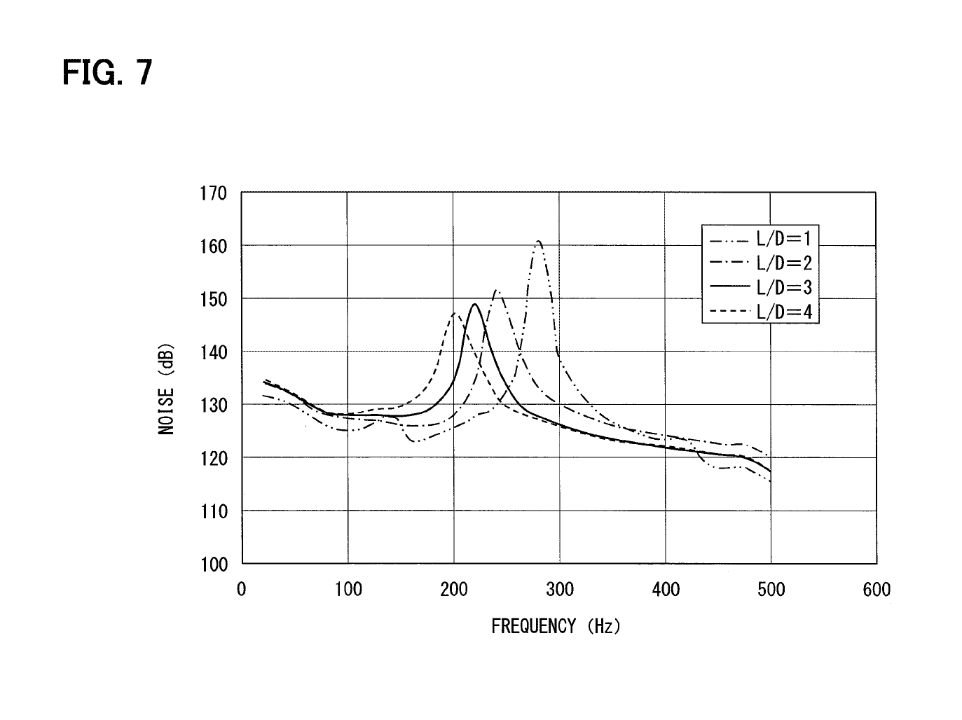

In the inside residual pressure holding valve 475 to construct a spring-mass system in this way, there is a concern that the valve element 475b when a lift amount (amount of separation from the valve seat) from the valve seat 475as is small or the like is subjected to a pressure pulsation caused by the fuel being pressure-sent from the fuel pump 42 and is hence vibrated. However, as described above, in the present embodiment, the passage diameter D of the circular pipe P, which is transformed from the passage cross-sectional area of the inside passage part 470g, and the length L of the inside passage part 470g are set in such a way as to satisfy the relational expression of L/D≧3. As a result of this setting, a vibration of the valve element 475b caused by the pressure pulsation, as shown in FIG. 6, is attenuated substantially to a zero level as time elapses. Hence, as shown in FIG. 7, noise caused in a path from the fuel passage 470 to the internal combustion engine 3 can be reduced. In this regard, in FIG. 6 and FIG. 7, a case where L/D=3 and a case where L/D=4 are shown as the present embodiment, whereas a case where L/D=1 and a case where L/D=2 are shown as comparative examples.

As shown in FIG. 2, the relief passage 476 is formed in a shape of a circular cylinder in a middle portion positioned between the discharge passage 472 and the branch passage 474 in the vertical direction of the protruding part 47. The relief passage 476 is branched to a direction orthogonal to the axial direction of the filter case 43 from the downstream side of the discharge passage 472 in the downstream straight part 470c. The relief passage 476 communicates with a relief port 442 of the port member 44, thereby guiding the fuel, which is branched from a flow directed to the internal combustion engine 3 side on the downstream side of the outside residual pressure holding valve 473 in the filter case 43, to a relief valve 443.

The port member 44 is formed of resin in a hollow shape and is arranged in the sub-tank 20. As shown in FIG. 2, FIG. 3, and FIG. 5, the port member 44 is bonded to the protruding part 47 at the specified position S by welding. The port member 44 is projected from the protruding part 47 in a direction orthogonal to the axial direction of the filter case 43. Here, in particular, the port member 44 of the present embodiment is projected in a tangential direction of a circular contour of an outer peripheral surface 461a of the outer cylinder part 461 curved in a shape of a circular cylinder. In addition, in the present embodiment, an amount of projection of the port member 44 is set in such a way that a diameter of a circumscribed circle C (see FIG. 3) is made as small as possible, the circumscribed circle C being tangent to an outer periphery of the filter case 43 including an outer periphery of the protruding part 47 which is an outer periphery of the specified position S and also to an outer periphery of the port member 44.

The port member 44 is integrally provided with the discharge port 440, the jet port 441, the relief port 442, and the relief valve 443 outside the filter case 43.

The discharge port 440 is formed in a shape of a space shaped like a letter L in an upper portion in the vertical direction of the port member 44. The discharge port 440 communicates with the discharge passage 472 opening in a side face 47a of the protruding part 47, as shown in FIG. 2. In addition, the discharge port 440 has its most downstream end directed upward on a side opposite to a position in which the discharge port 440 communicates with the discharge passage 472, thereby communicating with the flexible tube 12a. Since the discharge port 440 communicates with the discharge passage 472 and the flexible tube 12a in this way, the discharge port 440 communicates with the fuel passage 470 in the filter case 43 via the discharge passage 472 and communicates with the internal combustion engine 3 side outside the filter case 43 via the flexible tube 12a and the fuel supply pipe 12. In this way, the discharge port 440 which makes the inside and the outside of the filter case 43 communicate with each other discharges the fuel, which is circulated from the fuel passage 470 to the discharge passage 472, to the internal combustion engine 3 side.

The jet port 441 is formed in a shape of a space shaped like an inverse letter L in a lower end portion positioned below the discharge port 440 of the port member 44. The jet port 441 communicates with the branch passage 474 opening in the side face 47a of the protruding part 47 and communicates with the jet pump 45 on a side opposite to a position in which the jet port 441 communicates with the branch passage 474. Since the jet port 441 communicates with the branch passage 474 and the jet pump 45 in this way, the jet port 441 communicates with the inside passage part 470g in the filter case 43 via the branch passage 474 and directly communicates with the jet pump 45 outside the filter case 43. The jet port 441, which makes the inside and the outside of the filter case 43 communicate with each other, exerts a guide action directed to the jet pump 45 to the fuel discharged from the fuel passage 470 through the inside residual pressure holding valve 475.

The relief port 442 is formed in a shape of a stepped circular cylindrical hole at a middle portion positioned between the discharge port 440 and the jet port 441 in the vertical direction of the port member 44. The relief port 442 communicates with the relief passage 476 opening in the side face 47a of the protruding part 47 and communicates with the relief valve 443 on a side opposite to the position in which the relief port 442 communicates with the relief passage 476. Since the relief port 442 communicates with the relief passage 476 and the relief valve 443 in this way, the relief port 442 communicates with the fuel passage 470 in the filter case 43 via the relief passage 476 and directly communicates with the relief valve 443 outside the filter case 43. In this way, the relief port 442, which makes the inside and the outside of the filter case 43 communicate with each other, exerts the guide function directed to the relief valve 443 to the fuel branched from a flow to the internal combustion engine 3 side in the fuel passage 470.

As shown in FIG. 2 and FIG. 5, the relief valve 443 is a check valve of a spring-biased type and is provided in the relief port 442. In the relief port 442, the relief valve 443 communicates with the fuel passage 470 via the relief passage 476. In addition, the relief valve 443 communicates with the internal space 26 of the sub-tank 20 through a most downstream end 442a of the relief port 442, thereby discharging the fuel, which is guided to the relief port 442 from the relief passage 476, to the internal space 26. The relief valve 443 is provided with a valve retainer 443a, a valve element 443b, and a valve spring 443c.

As shown in FIG. 2, the valve retainer 443a is formed of resin in a shape of a circular cylinder and is fitted in the port member 44. Of the relief port 442, the most downstream end 442a on the downstream side of a stepped portion forming a valve seat 442s in a flat shape is passed through the valve retainer 443a.

The valve element 443b is formed of a composite material of resin and rubber in a shape of a circular disc and is received coaxially in the relief port 442. Since the valve element 443b is received in this way, when the valve element 443b is moved back and forth, the valve element 443b can be seated on and separated from the valve seat 442s. Hence, when the valve element 443b is separated from the valve seat 442s, the relief valve 443 is opened. On the other hand, when the valve element 443b is seated on the valve seat 442s, the relief valve 443 is closed.

The valve spring 443c is formed of metal in a shape of a coil. The valve spring 443c is received coaxially in the relief port 442 and is retained by the valve retainer 443a. The valve spring 443c biases the valve element 443b to the valve seat 442s side by a spring reaction force.

According to this structure, the relief valve 443 opens or closes the fuel passage 470 communicating with the relief port 442 via the relief passage 476. Specifically, while irrespective of the fuel pump 42 being actuated or stopped, a fuel supply passage from the fuel passage 470 to the internal combustion engine 3 is held in a formal state and the pressure in the relief port 442 is less than a relief pressure, the valve element 443b of the relief valve 443 is closed by the spring reaction force of the valve spring 443c. When the valve element 443b of the relief valve 443 is closed, the fuel whose pressure is regulated by the actuation of the fuel pump 42 is discharged through the discharge passage 472 in the filter case 43 and through the discharge port 440 outside the filter case 43, whereby the fuel is supplied to the internal combustion engine 3 side. On the other hand, when irrespective of the fuel pump 42 being actuated or stopped, an abnormality is caused in a fuel supply path from the fuel passage 470 to the internal combustion engine 3 and the fuel whose pressure is not less than the relief pressure is guided to the relief port 442, the valve element 443b is opened against the spring reaction force of the valve spring 443c. When the valve element 443b is opened, the fuel guided to the relief valve 443 is discharged to the internal space 26 of the sub-tank 20 in a state where the valve element 443b is resiliently held by the valve spring 443c, so that the pressure of the fuel supplied to the internal combustion engine 3 side is relived to the relief pressure. In other words, a relief function by the opened relief valve 443 is exerted to the fuel supplied to the internal combustion engine 3 side. In this regard, the relief pressure by the relief function of the relief valve 443 is set to, for example, 650 kPa.

As shown in FIG. 2 and FIG. 5, the jet pump 45 is formed of resin in a hollow shape and is arranged below the port member 44 in the sub-tank 20. The jet pump 45 is placed especially on the depressed bottom part 20b of the bottom part 20a of the sub-tank 20. Since the jet pump 45 is placed in this way, the jet pump 45 and the port member 44 overlap the inflow port 24 in the axial direction of the filter case 43 above the bottom part 20a shown in FIG. 2. The jet pump 45 is integrally provided with a pressuring part 450, a nozzle part 451, a suction part 452, and a diffuser part 453.

The pressurizing part 450 has a pressurizing passage 454 formed in a shape of a stepped circular cylindrical hole extending along the axial direction of the filter case 43. The pressurizing passage 454 is positioned below the port member 44 and communicates with the jet port 441. Since the pressurizing passage 454 communicates with the jet port 441 in this way, the pressurized fuel discharged from the inside passage part 470g through the inside residual pressure holding valve 475 inside the filter case 43 is guided to the pressurizing passage 454 via the jet port 441 outside the filter case 43.

The nozzle part 451 has a nozzle passage 455 formed in a shape of a circular cylindrical hole extending in a direction orthogonal to the axial direction of the filter case 43. The nozzle passage 455 is positioned below the pressuring part 450 and communicates with the pressuring passage 454. Further, the nozzle passage 455 has its passage cross-sectional area reduced as compared with the inside passage part 470g and the pressuring passage 454 on the upstream side thereof. Since the nozzle part 451 communicates with the pressurizing passage 454 and is reduced in the passage cross-sectional area in this way, the pressurized fuel guided to the pressurizing passage 454 flows into the nozzle passage 455.

The suction part 452 has a suction passage 456 formed in a shape of a flat space expanding in the direction orthogonal to the axial direction of the filter case 43. The suction passage 456 is positioned below the pressurizing part 450 and the nozzle part 451 and communicates with the inflow port 24. Since the suction passage 456 communicates with the inflow port 24 in this way, the fuel flowing into the sub-tank 20 through the inflow port 24 is circulated in the suction passage 456.

The diffuser part 453 has a diffuser passage 457 formed in a shape of a circular cylindrical hole extending in the direction orthogonal to the axial direction of the filter case 43. The diffuser passage 457 is positioned below the pressurizing part 450 and communicates with the nozzle passage 455 and communicates with the internal space 26 of the sub-tank 20 on a side opposite to a position in which the diffuser passage 457 communicates with the nozzle passage 455. Further, the diffuser passage 457 has its passage cross-sectional area enlarged as compared with the nozzle passage 455. Since the diffuser passage 457 communicates with the nozzle passage 455 and the internal space 26 and has the passage cross-sectional area enlarged in this way, when the pressurized fuel, which flows into the nozzle passage 455 and has its flow rate reduced, is jetted out to the diffuser passage 457 to cause a negative pressure around a jetted flow, the fuel in the fuel tank 2 is sucked from the inflow port 24 into the suction passage 456 and the diffuser passage 457 in sequence. The fuel sucked in this way is subjected to a diffuser action in the diffuser passage 457 and is pressure-sent, thereby being transported to the internal space 26 including the surroundings of the fuel pump 42.

In this regard, in the present embodiment, the diffuser passage 457, which has a cross section formed in a circular shape having a large diameter, has its center aligned with the nozzle passage 455, which has a cross section formed in a circular shape having a small diameter. In addition, the most downstream end 457a, which communicates with the internal space 26 in the diffuser passage 457 of the present embodiment, is separated upward from the deepest bottom part 20d of the bottom part 20a of the sub-tank 20.

An operation and effect of the present embodiment described above will be described below.

According to the present embodiment, the outside residual pressure holding valve 473, which holds the pressure of the fuel supplied to the internal combustion engine 3 side when the fuel pump 42 is stopped, is the valve of a spring-less type having the valve element 478 which is opened and is retained by the valve stopper 479 when the fuel pump 42 is actuated. For this reason, even if the pressure pulsation is caused by the fuel being pressure-sent from the fuel pump 42, the valve element 478 retained by the valve stopper 479 is hard to be vibrated.

On the other hand, the inside residual pressure holding valve 475, which holds the pressure of the fuel in the receiving chamber 463 when the fuel pump 42 is stopped, is the valve of a spring-biased type having the valve element 475b which is opened against the spring reaction force when the fuel pump 42 is actuated. Here, of the fuel passage 470 in which the fuel discharged to the internal combustion engine 3 side is circulated, the communication port 470e, which communicates with the receiving chamber 463 on the downstream side of the fuel filter 464, opens at the shifted position R which is shifted in position from the inside residual pressure holding valve 475 to the outside residual pressure holding valve 473. In this way, in the fuel passage 470, the length L of the inside passage part 470g, which throttles the fuel flow from the communication port 470e to the inside residual pressure holding valve 475 side, can be enlarged in such a way as to satisfy the relational expression of L/D≧3 as compared with the outside passage part 470f in which the fuel is directed from the communication port 470e to the outside residual pressure holding valve 473. As a result, the pressure pulsation caused by the fuel being pressure-sent from the fuel pump 42 can be attenuated by the inside passage part 470g which is long extended to the inside residual pressure holding valve 475 of a spring-biased type to thereby throttle the fuel flow, so that also the vibration of the valve element 475b in the inside residual pressure holding valve 475 can be attenuated.

From the above description, in each of the outside residual pressure holding valve 473 and the inside residual pressure holding valve 475, the pressure pulsation can be inhibited from being amplified by the vibration of each of the valve elements 478, 475b. Hence, it is possible to reduce noise caused in the path from the fuel passage 470 to the internal combustion engine 3.

Further, according to the present embodiment, the communication port 470e, which communicates with the receiving chamber 463 via the relay passage 465, opens at the shifted position R. According to this, not only the length L of the inside passage part 470g, which throttles the fuel flow from the communication port 470e to the inside residual pressure holding valve 475, can be enlarged in such a way as to satisfy the relational expression of L/D≧3, but also the length of the relay passage 465 from the receiving chamber 463 to the communication port 470e can be enlarged. As a result, before the pressure pulsation caused by the fuel being pressure-sent from the fuel pump 42 reaches the inside residual pressure holding valve 475 of a spring biased type, the pressure pulsation can be attenuated by the long relay passage 465 and by the inside passage part 470g which is long extended to thereby throttle the fuel flow. Hence, it is possible to improve an effect of reducing noise.

Further, according to the present embodiment, the communication port 470e opening in the outside passage part 470f at the shifted position R communicates with the inside passage part 470g via the outside passage part 470f. Here, the fuel flow is more throttled in the inside passage part 470g than in the outside passage part 470f, so that it is possible to secure the flow rate of the fuel, which is circulated in the outside passage part 470f so as to be discharged to the internal combustion engine 3 side, and at the same time to attenuate the pressure pulsation in the inside passage part 470g to thereby reduce noise. Further, the inside passage part 470g opens at the separated position Q which is separated in the radial outward direction from the relay passage 465 across the inside residual pressure holding valve 475 of the outside passage part 470f, so that a distance from the communication port 470e to the separated position Q of the outside passage part 470f can be increased together with the length of the relay passage 465. As a result, before the pressure pulsation which is caused by the fuel being pressure-sent from the fuel pump 42 reaches the inside residual pressure holding valve 475 of a spring biased type, the pressure pulsation can be attenuated by the long relay passage 465, a distance secured between the shifted position R and the separated position Q, and the inside passage part 470g which is long extended to thereby throttle the fuel flow. Hence, it is possible to improve the effect of reducing noise.

Still further, according to the present embodiment, the direction in which the fuel is circulated in the inside passage part 470g is inclined with respect to the direction in which the fuel is circulated in the relay passage 465. In this way, the fuel flow from the relay passage 465 to the inside passage part 470g through the outside passage part 470f is smoothly folded back, which hence makes it difficult for the fuel flow to separate from an inner surface forming the outside passage part 470f and the inside passage part 470g. Hence, it is possible to inhibit a negative pressure from being produced by the separation of the fuel flow to thereby cause noise.

In addition, according to the present embodiment, in the protruding part 47 protruding from the specified position S in the peripheral direction of the filter case 43 are received not only the inside residual pressure holding valve 475 at the separated position Q but also the outside passage part 470f and the inside passage part 470g. According to this protruding part 47, the distance between the shifted position R and the separated position Q can be secured and at the same time the diameter of the circumscribed circle C can be reduced, the circumscribed circle C being tangent to the outer periphery of the filter case 43 including the specified position S in which the inside residual pressure holding valve 475 is provided together with the outside passage part 470f and the inside passage part 470g. Hence, it is possible to achieve both of the effect of reducing noise and an effect of reducing the size of the fuel supply device 1.

In further addition, according to the present embodiment, both of the outside residual pressure holding valve 473 and the inside residual pressure holding valve 475 are integrated with the outside passage part 470f and the inside passage part 470g, which are directed respectively to the outside residual pressure holding valve 473 and the inside residual pressure holding valve 475, in a manner deviated at the specified position S. According to this construction, in a state where the diameter of the circumscribed circle C tangent to the outer periphery of the filter case 43 is reduced, the pressure pulsation can be attenuated in the inside passage part 470g to satisfy the relational expression of L/D≧3, which is related to the outside residual pressure holding valve 473, the inside residual pressure holding valve 475, and the outside passage part 470f. Hence, it is possible to achieve both of the effect of reducing noise and the effect of reducing the size of the fuel supply device 1.

In still further addition, according to the present embodiment, the fuel branched from the fuel flow directed to the internal combustion engine 3 side in the fuel passage 470 is guided by the relief passage 476, so that the relief valve 443 relives the pressure of the fuel supplied to the internal combustion engine 3 side. According to such a relief function, the durability of the internal combustion engine 3 can be secured. Further, the relief valve 443 of a spring biased type, in which the valve element 443b is opened against the spring reaction force so as to relieve the pressure, has the fuel guided thereto from the downstream side of the outside residual pressure holding valve 473 of the fuel passage 470 through the relief passage 476. In this way, a distance from the communication port 470e to the relief valve 443 via the fuel passage 470 and the relief passage 476 is elongated, so that the pressure pulsation caused by the fuel being pressure-sent from the fuel pump 42 can be attenuated. Hence, in the relief valve 443, the pressure pulsation can be inhibited from being amplified by the vibration of the valve element 443b, so that it is possible to enhance the effect of reducing noise caused in the path from the fuel passage 470 to the internal combustion engine 3.

In still further addition, the jet pump 45 of the present embodiment further throttles and jets out the fuel discharged from the inside passage part 470g, which is long extended to thereby throttle the fuel flow in such a way as to satisfy the relational expression of L/D≧3, through the inside residual pressure holding valve 475, thereby transporting the fuel in the fuel tank 2 to the surroundings of the fuel pump 42. In this way, in the jet pump 45, the fuel in which pressure pulsation is attenuated by the inside passage part 470g can be jetted out, so that it is possible to stably exert a fuel transportation function and to inhibit noise harsh to human ears from being caused by the fuel being intermittently jetted out.

Although one embodiment has been described above, it should not be understood that the present disclosure is limited to the present embodiment but the present disclosure can be applied to various embodiments within a scope not departing from the gist of the present disclosure. Modified examples of the embodiment described above will be described below.

Specifically, in a first modification, the filter case 43 may be not provided with the relay passage 465 but the fuel outlet 463a of the receiving chamber 463 may be substantially matched with the communication port 470e. Further, in a second modification, the direction in which the fuel is circulated in the relay passage 465 may be substantially orthogonal to or substantially parallel to the direction in which the fuel is circulated in the inside passage part 470g.

In a third modification, the inside residual pressure holding valve 475 may be provided at the separated position Q which is separated from the relay passage 465 across the inside passage part 470g and the inside passage part 470g may be opened at a position closer to the relay passage 465 than the separated position Q of the outside passage part 470f. Further, in a forth modification, the communication port 470e may be opened in the inside passage part 470g at the shifted position R, whereby the outside passage part 470f may be made to communicate with the communication port 470e via the inner passage port 470g.

In a fifth modification, at least one of the outside residual pressure holding valve 473 and the inside residual pressure holding valve 475 may be provided in a portion other than the protruding part 47 at the specified position S of the filter case 43. Further, in a sixth modification, in a construction in which the protruding part 47 is not provided, a non-receiving portion in which the fuel filter 464 is not received of the filter case 43 may be provided at a portion in the peripheral direction of the filter case 43 and the non-receiving portion may be set to the specified position S.

In a seventh modification, the relief valve 443 of an electromagnetically driven type such as a solenoid valve may be provided. Further, in an eighth modification, the relief valve 443 may be not provided.

In a ninth modification, except for the fuel discharged from the inside passage part 470g through the inside residual pressure holding valve 475, for example, the fuel discharged from the fuel pump 42 or the fuel returned from the internal combustion engine 3 side may be jetted out in the jet pump 45. Further, in a tenth modification, the jet pump 45 may be not provided.

In an eleventh modification, the port member 44 divided into the discharge port 440, the jet port 441, and the relief port 442 may be employed. Further, in a 12th modification, the port member 44 divided in such a way as to correspond to one and two of the discharge port 440, the jet port 441, and the relief port 442 may be employed.

While the present disclosure has been described with reference to embodiments thereof, it is to be understood that the disclosure is not limited to the embodiments and constructions. The present disclosure is intended to cover various modification and equivalent arrangements. In addition, the various combinations and configurations, other combinations and configurations, including more, less or only a single element, are also within the spirit and scope of the present disclosure.

1. A fuel supply device comprising:
a fuel pump;
a filter case that receives a fuel filter in its receiving chamber, wherein the fuel supply device filters fuel, which is pressure-sent from an interior of a fuel tank by the fuel pump, through the fuel filter and supplies fuel to an internal-combustion engine;
a fuel passage that is provided in the filter case and includes a communication port, which communicates with the receiving chamber on a downstream side of the fuel filter, wherein fuel to be discharged through the communication port into the internal-combustion engine flows through the fuel passage;
a spring-less type outside residual pressure holding valve that is provided at the filter case and holds a pressure of the fuel supplied to the internal-combustion engine when the fuel pump is stopped, wherein the outside residual pressure holding valve includes a valve stopper and a valve element, which opens the outside residual pressure holding valve when the fuel pump is actuated to be engaged with the valve stopper; and
a spring-urged type inside residual pressure holding valve that is provided at the filter case and holds a pressure of fuel in the receiving chamber when the fuel pump is stopped, wherein:
the inside residual pressure holding valve includes a valve element, which opens the inside residual pressure holding valve against spring reaction force when the fuel pump is actuated;
the communication port opens at a shifted position of the fuel passage that is positionally shifted from the inside residual pressure holding valve toward the outside residual pressure holding valve;
the fuel passage includes:
an outside passage part through which the fuel to be discharged into the internal-combustion engine flows from the communication port toward the outside residual pressure holding valve; and
an inside passage part that throttles a flow of fuel flowing from the communication port toward the inside residual pressure holding valve more than the outside passage part; and
when a passage cross-sectional area of the inside passage part is converted into a passage cross-sectional area of a circular pipe, D which is a passage diameter of the circular pipe, and L which is a length of the inside passage part satisfy a relational expression of L/D≧3.

2. The fuel supply device according to claim 1, further comprising a relay passage that is provided in the filter case to communicate between the receiving chamber and the communication port.

3. The fuel supply device according to claim 2, wherein:
the communication port opens into the outside passage part at the shifted position; and
the inside passage part opens at a separated position of the outside passage part that is separated from the relay passage with the inside residual pressure holding valve between the separated position and the relay passage to communicate with the communication port via the outside passage part.

4. The fuel supply device according to claim 3, wherein a flow direction of fuel through the relay passage is inclined with respect to a flow direction of fuel through the inside passage part, so that the fuel flow from the relay passage turns around toward the inside passage part through the outside passage part.

5. The fuel supply device according to claim 3, wherein:
the filter case includes a protruding part protruding from its specified position in a circumferential direction of the filter case; and
the outside passage part and the inside passage part are received in the protruding part together with the inside residual pressure holding valve at the separated position.

6. The fuel supply device according to claim 1, wherein the communication port opens into the outside passage part at the shifted position to communicate with the inside passage part via the outside passage part.

7. The fuel supply device according to claim 1, wherein the filter case integrally includes the outside residual pressure holding valve and the inside residual pressure holding valve together with the outside passage part and the inside passage part in a manner deviated at its specified position in a circumferential direction.

8. The fuel supply device according to claim 1, further comprising:
a spring-urged type relief valve that relieves the pressure of the fuel supplied to the internal-combustion engine through the fuel passage and that includes a valve element, which opens the relief valve against spring reaction force to relive the pressure; and
a relief passage that is provided in the filter case to guide fuel, which branches from a flow of the fuel toward the internal-combustion engine, to the relief valve on a downstream side of the outside residual pressure holding valve in the fuel passage.

9. The fuel supply device according to claim 1, further comprising a jet pump that throttles and jets out fuel, which is discharged from the inside passage part through the inside residual pressure holding valve, to transport fuel in the fuel tank to a periphery of the fuel pump.
